(19) United States
(12) Patent Application Publication
(10) Pub. No.: US 2024/0167280 A1
(43) Pub. Date: May 23, 2024

(54) Vented Weather Resistant Barriers

(71) Applicant: Martco L.L.C., Alexandria, LA (US)

(72) Inventor: Bobby J. Byrd, Alexandria, LA (US)

(21) Appl. No.: 18/539,121

(22) Filed: Dec. 13, 2023

Related U.S. Application Data
(63) Continuation-in-part of application No. 18/514,432, filed on Nov. 20, 2023.
(60) Provisional application No. 63/426,894, filed on Nov. 21, 2022.
(60) Provisional application No. 63/434,780, filed on Dec. 22, 2022.

(51) Int. Cl. E04C 2/52; B32B 3/30; B32B 5/02; B32B 21/02; B32B 21/10; B32B 29/02; E04C 2/26

(52) U.S. Cl. CPC E04C 2/523; B32B 3/30; B32B 5/028; B32B 21/02; B32B 21/10; B32B 29/02; E04C 2/26; B32B 2307/7376; B32B 2607/00

(57) ABSTRACT

Vented weather resistant barrier panels are disclosed that facilitate the removal of volatile organic compounds or other gases. The vented weather resistant barrier panels have a panel with a first side formed with a plurality of channels and covered with a non-perforated barrier to form a flow path. In some embodiments, the barrier is formed from a foil layer and a carrier layer. When installed on a structure, the vented weather resistant barrier panels form a flow path from inside the wall of the structure, through the channels, and through a first or second end of each channel to allow for ventilation of the structure. Methods of ventilating a structure using vented weather resistant barrier panels and of manufacturing vented weather resistant barrier panels are also disclosed.

### CROSS-REFERENCE TO RELATED APPLICATION

This application is a continuation-in-part of U.S. Non-Provisional application Ser. No. 18/514,432 filed by Bobby J. Byrd, on Nov. 20, 2023, entitled “Vented Radiant Barriers,” which claims the benefit of U.S. Provisional Application Ser. No. 63/426,894, filed by Bobby J. Byrd, on Nov. 21, 2022, entitled “Vented Radiant Barriers;” This application also claims the benefit of U.S. Provisional Application Ser. No. 63/434,780, filed by Bobby J. Byrd, on Dec. 22, 2022, entitled “Vented Weather Radiant Barriers.” All these applications are incorporated herein by reference in their entirety for all purposes.

### TECHNICAL FIELD

This application is directed, in general, to residential construction, and more specifically, to vented weather resistant barriers.

### BACKGROUND

The following discussion of the background is intended to facilitate an understanding of the present disclosure only. It should be appreciated that the discussion is not an acknowledgement or admission that any of the material referred to was part of the common general knowledge at the priority date of the application.

Many types of exterior coverings have been used in housing for many decades. Exterior coverings such as structural wood sheathing provide structural integrity to organize and protect a structure by preventing entry into the structure by moisture and pests. Exterior coverings also provide an insulation factor to a structure by preventing the exchange of air between the interior of a structure and the exterior of a structure, thereby reducing the cooling or heating load of the structure. While structural wood sheathing has been used as an exterior covering, other materials and improvements remain desirable.

### SUMMARY

According to an illustrative embodiment, a vented weather resistant barrier panel includes a panel having a first and a second side. The panel is formed with a plurality of channels on the first side of the panel. A non-perforated barrier is coupled to the first side of the panel and extends across the plurality of channels to form ventilation pathways. When in an installed position on framing members of a structure, the first side of the panel faces the exterior of a structure and the second side faces the interior of the structure. In some embodiments the barrier is a foil layer or a combination of a foil layer and a carrier layer.

According to an illustrative embodiment, a method for ventilating a structure includes the steps of attaching a plurality of vented weather resistant barrier panels to an exterior side of a plurality of studs of a wall of a structure and installing wall covering material over the second side of each of the plurality of vented weather resistant barrier panels. Each of the plurality of vented weather resistant barrier panels includes a panel having a first and a second side, with a plurality of channels formed on the first side of the panel and a non-perforated barrier attached to the first side of the panel and covering the plurality of channels. In some embodiments the barrier is a foil layer or a combination of a foil layer and a carrier layer. The plurality of vented weather resistant barrier panels is installed with the barrier facing the towards an exterior of the structure and with either a first end or a second end of at least one of the plurality of channels in fluid communication with either the exterior of the structure or an attic cavity of the structure, to create a flow path for venting vapors from a structure.

According to an illustrative embodiment, a vented weather resistant barrier panel includes a panel formed with a plurality of channels on one side running along a dimension of the panel and having a thickness of at least 0.25 inches and a non-perforated barrier coupled over the plurality of channels of the panel to form a plurality of ventilation pathways. In some embodiments, the barrier comprises a foil layer and a carrier layer coupled to each other. In some embodiments, the panel has a thickness in the range of 1.0-0.375 inches and a depth of at least one of the plurality of channels is in the range of 30-50% of a thickness of the panel.

Other embodiments and methods are disclosed herein.

### DESCRIPTION OF THE DRAWINGS

Illustrative embodiments of the present invention are described in detail below with reference to the attached drawing figures, which are incorporated by reference herein and wherein:

FIG. 1A is a schematic, elevation view of a structure with vented weather resistant barriers according to an illustrative embodiment;

FIG. 1B is a detailed view of a portion of the vented weather resistant barrier of FIG. 1A;

FIG. 2A is a schematic, top cross-sectional view of a portion of a wall assembly utilizing a vented weather resistant barrier according to an illustrative embodiment;

FIG. 2B is a detailed cross-sectional view of a portion of the vented weather resistant barrier of FIG. 2A;

FIG. 3 is a schematic, perspective view of a portion of a vented weather resistant barrier according to an illustrative embodiment;

FIG. 4 is a schematic cut away side elevation view of a structure having a vented weather resistant barrier according to an illustrative embodiment; and

FIG. 5 is a schematic, partial cut away, exterior view of a wall assembly utilizing a vented weather resistant barrier according to an illustrative embodiment.

### DETAILED DESCRIPTION

In the following detailed description of the preferred embodiments, reference is made to the accompanying drawings that form a part hereof, and in which is shown, by way of illustration, specific embodiments in which the invention may be practiced. These embodiments are described in sufficient detail to enable those skilled in the art to practice the invention, and it is understood that other embodiments may be utilized, and that logical structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the claims.

Unless otherwise indicated, as used throughout this document “or” does not require mutual exclusivity.

One of the potential issues with the application of weather resistant barriers (“WRB”) in the residential housing market has to do with the accumulation of undesired vapors, such as volatile organic compounds (VOCs), within the interior of a structure. It is desirable to use an exterior covering that is capable of preventing the unwanted entry of moisture, preventing moisture damage, and preventing the exchange of air between the interior and exterior of a building, which would result in a decrease in the structures insulation value and therefore an increase in heating and cooling costs.

According to an aspect of the present invention, a WRB is vented. A vented weather resistant barrier is provided that includes channels that form ventilation pathways to help remove any such vapor or VOCs as will be described in more detail below.

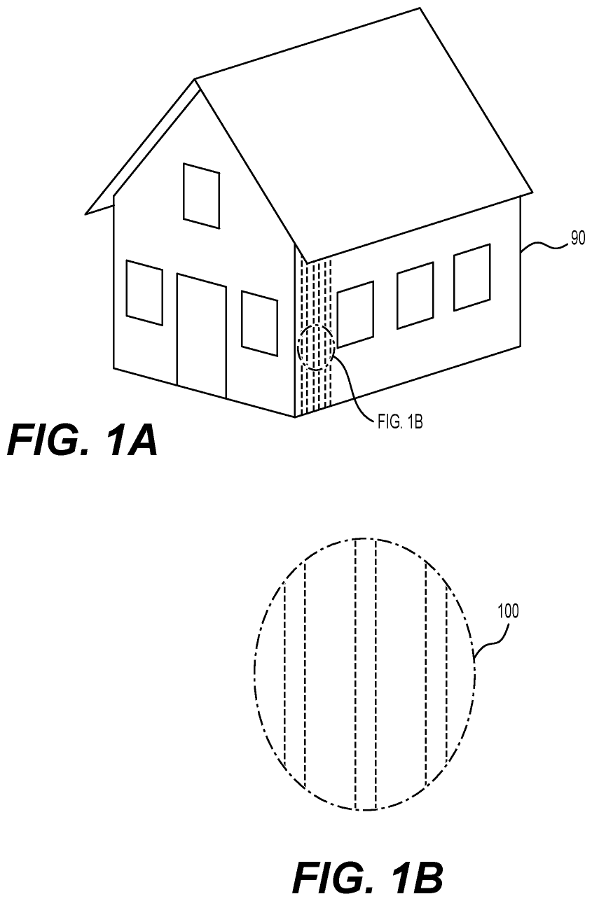

Referring now to FIGS. 1A and 1B, which depict an illustrative embodiment of a vented weather resistant barrier 100. FIG. 1A depicts the vented weather resistant barrier 100 installed onto the exterior wall of a house 90 or other building. FIG. 1B is a detailed view of vented weather resistant barrier 100. It should be noted that, when used as an exterior wall covering, the vented weather resistant barrier 100 is primarily used as a substrate for a final wall covering, such as exterior siding, but this is not necessarily required. A final wall covering is not shown in FIG. 1A.

Any number of types of final wall coverings known in the art may be installed over the vented weather resistant barrier 100, including wood sheathing, wood siding, polymer or plastic siding, stucco, brick, etc. Installing a final wall covering over the vented weather resistant barrier 100 provides a protective covering to prevent damage to the vented weather resistant barrier 100.

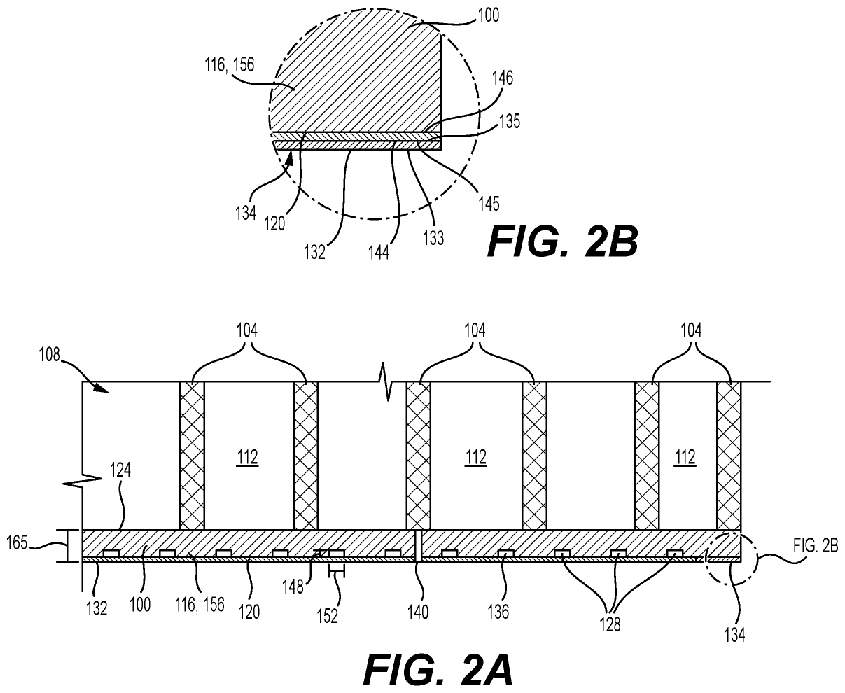

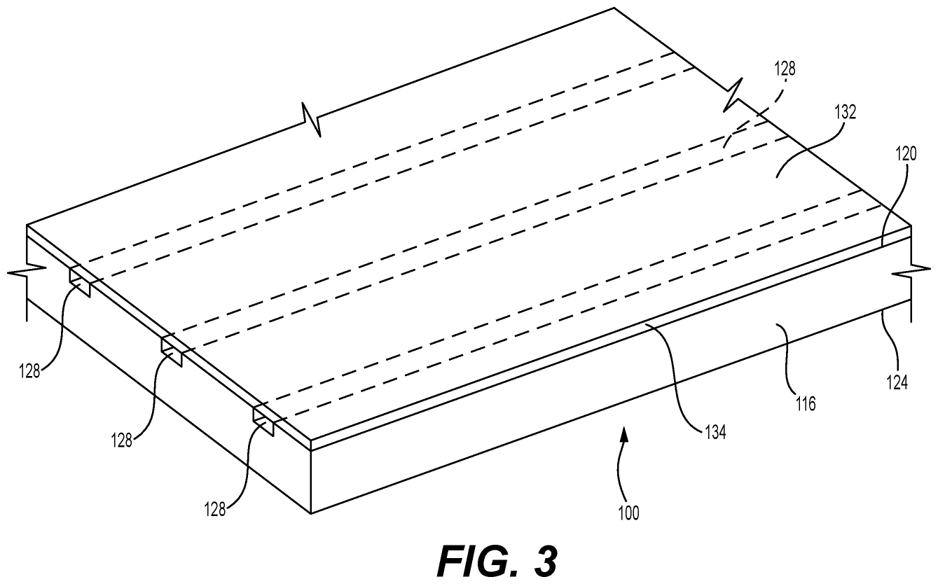

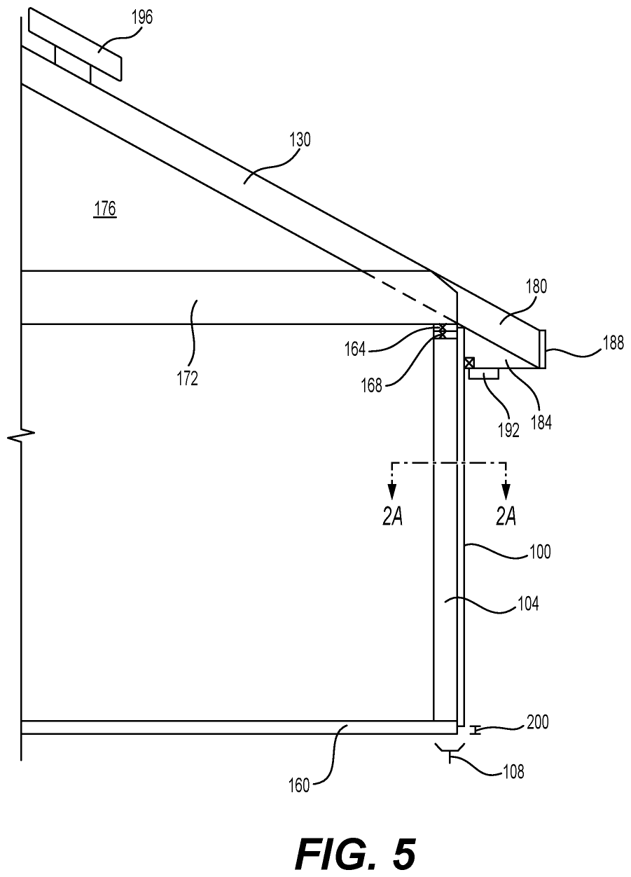

Referring now primarily to FIGS. 2A, 2B, and 3 the illustrative vented weather resistant barrier 100 is shown in a cross-sectional view (from the top) installed on a wall assembly of a house in FIG. 2A (the location of the cross-section of FIG. 2A is shown in FIG. 5); a detailed view the vented resistant barrier 100 is shown in FIG. 2B; and a schematic, perspective view of a portion of a vented weather resistant barrier is shown in FIG. 3. The vented weather resistant barrier 100 is installed onto structural framing members, such as the studs 104 of a wall assembly 108.

The vented weather resistant barrier 100 includes a panel 116 having a first side 120 and a second side 124. In an installed position, the first side 120 faces outward (i.e. away from the house) and the second side 124 faces inward, i.e. towards a wall cavity. The panel 116 is formed with a plurality of channels 128 on the first side 120 of the panel 116 and running a length of the panel 116. In some embodiments, each of the channels of the plurality of channels 128 are substantially parallel to each other. In the installed position, the plurality of channels 128 are parallel to the studs 104. The vented weather resistant barrier 100 further includes a foil layer 132, or a laminate, which is coupled to the first side 120 of the panel 116 and extends across the plurality of channels 128 to form ventilation pathways 136. The foil layer 132 is not perforated, and therefore, the foil layer 132 prevents moisture egress into the wall assembly 108 through the panel 116.

The foil layer 132 is coupled to a carrier 144 (FIG. 2B), such as kraft paper. The carrier 144, however, may be any suitable material that provides structural support for the foil layer 132. In some embodiments, the carrier 144 is a scrim fiber mesh. Those skilled in the art will appreciate that other materials may be used or no carrier material may be used. An adhesive, such as a polyvinyl acetate (PVA) glue or other non-carcinogenic water-based adhesive binder is used to adhere the foil layer 132 to the carrier 144. The carrier 144 is further coupled to the panel 116 using an adhesive, such as a polyvinyl acetate (PVA) glue or other non-carcinogenic water-based adhesive binder. In some embodiments the carrier 144 is not used, and the foil layer 132 is coupled directly to the panel 116 using an adhesive. The foil layer 132 has a first side 133 and a second side 135. The carrier 144 has a first side 145 and a second side 146. The second side 135 of the foil layer 132 is couple to the first side 145 of the carrier 144.

The foil layer 132 alone or the combination of the foil layer 132 and the carrier 144 form a barrier 134 which covers the first side 120 of the panel 116. The barrier 134 prevents moisture and gas flows from the exterior of the structure to which the vented weather resistant barrier 100 is attached. The barrier 134 also covers the plurality of channels 128 to form the ventilation pathways 136. In some embodiments, the barrier 134 is formed only of the foil layer 132. As used herein “foil” may be a very thin sheet of metal, e.g., aluminum foil, that resists moisture content. In another embodiment, a “foil” can be any thin material that can cover the channel and not readily condensate or deteriorate, e.g., paper film. An aluminum foil is used in some embodiments to provide low E value for energy savings and to enhance the fire rating of the panel. In other embodiments, the barrier 134 is formed by the combination of the foil layer 132 and the carrier 144. In other embodiments, the barrier 134 is any non-perforated moisture or gas resistant sheeting material, for example the barrier 134 may be made from plastics, polymers, rubbers, etc. Any impervious material that can pass the weather resistant barrier criteria may be used. The material does not have a perforated film. A typical foil may be added for an added benefit; the foil is the energy performance of that surface, due to low emittance.

When multiple vented weather resistant barriers 100 adjoin each other on wall assembly 108, a space 140, or gap, is left between adjacent vented weather resistant barriers 100, to allow for ventilation and expansion and contraction. The space 140 is typically ⅛ of an inch in width but may range from ¼ to ⅛ of an inch in width or another dimension.

Each channel 128 has a depth 148, see FIG. 2A, and a width 152. In some embodiments, the depth 148 is as deep as possible while maintaining United States Department of Commerce Performance Standard-2 structural integrity of the panel 116 in terms of the span strength. The depth 148 of the channels 128 is in the range of 30-55% of a thickness 165 of the panel 116, and in some embodiments is in the range of 35-45%. The channel 128 runs the length or width of the panel 116. The depth 148 of the channel 128 is small enough that the depth 148 does not negatively impact the structural integrity the panel 116. In one embodiment in which the panel 116 is plywood, the depth 148 of the channel 128 is 50% of the thickness 165 of the panel 116. In one illustrative embodiment in which the panel 116 is OSB with a thickness 165 of 7/16″ (0.438″), a channel depth 148 that reaches into the center layer of the panel while maintaining the panel's span rating. In some embodiments, the depth 148 is just sized to keep Dept. of Commerce PS2 qualification span rating. Those skilled in the art will appreciate that other dimension may be used. The width dimension of the channels may be ⅜″ in some embodiments. In other embodiments, the width of the channel can extent to the point of just not negatively effecting the USDOC span rating.

The panel 116 may be a United States Department of Commerce Performance Standard-2 structural wood-based panel 156, such veneered plywood, orientated strand board (OSB) or other cross laminated structural wood panels.

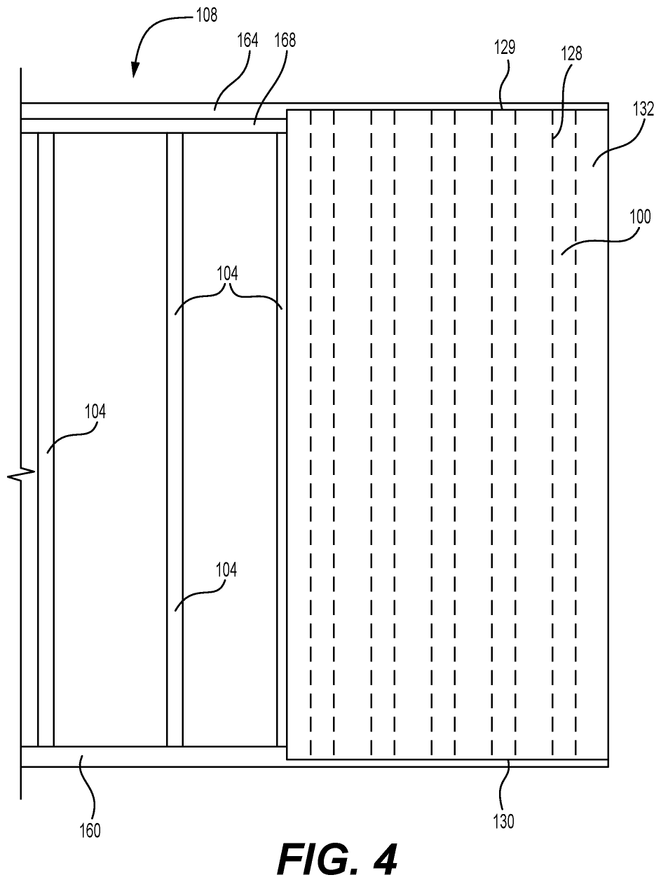

Referring now primarily to FIG. 4, a schematic, partial cut away, exterior view of a wall assembly 108 utilizing a vented weather resistant barrier 100 is shown. The vented weather resistant barrier 100 is shown installed on the wall assembly 108 in FIG. 4. The studs 104, a bottom plate 160 (or bottom member), a first top plate (top) 164, and a second top plate (bottom) 168 are joined to form the underlying structural components of the wall assembly 108 and provide a flat structural surface for attachment of the vented weather resistant barrier 100 to the wall assembly 108. Collectively, the combination of the studs 104, the bottom plate 160, the first top plate (top) 164, and the second top plate (bottom) 168, and other common framing components of structures are referred to as “framing members.” The vented weather resistant barrier 100 is attached using screws, nails, glues, staples, mechanical fasteners, a combination thereof, or other appropriate fasteners. The vented weather resistant barrier 100 is installed with the first side 120 facing the exterior of the structure and the second side 124 facing the interior of the structure. The foil layer 132, therefore, faces the exterior of the structure and prevents moisture entry into the structure through the vented weather resistant barrier 100. The channels 128, which are not visible in FIG. 4 because they are covered by the foil layer 132, are indicated as broken lines on the vented weather resistant barrier 100 in FIG. 4.

Referring now primarily to FIG. 5, a schematic diagram of a structure having a vented weather resistant barrier 100 according to an illustrative embodiment is shown. In this view, one may see the vented weather resistant barrier 100 installed on the wall assembly 108 so that the vented weather resistant barrier 100 is on the exterior side of the wall assembly 108. The vented weather resistant barrier 100 may be attached to the studs 104, bottom plate 160, first top plate (top) 164, and second top plate (bottom) 168. The wall assembly 108 joins to a ceiling joist 172. An attic cavity 176 is the open space between a plurality of ceiling joists 172 and a plurality of rafters 180. The rafters 180, a soffit panel 184, and a facia board 188 are joined to form a roof overhang, whose interior space is part of attic cavity 176. The attic cavity 176 is vented by a soffit vent 192 and an attic vent 196. Both the soffit vent 192 and the attic vent 196 allow for air flow between the attic cavity 176 and the exterior of the structure. Other ventilation sources may be used as well.

The channels 128 run the vertical length of the vented weather resistant barrier 100 from top to bottom. The channels 128 on their lower end are open to the exterior of the building. When installed the vented weather resistant barriers 100 are installed on wall assembly 108 with a gap 200 to allow for external air to flow into and out of the channels 128 at their lower end. The vented weather resistant barriers 100 are installed so that the top ends of channels 128 are open and may extend into attic cavity 176, which allows for air flow through the top of channels 128 into attic cavity 176. The channels 128 have a first end 129 and a second end 130.

With reference now generally to FIGS. 1A-5, when installed on a structure, the vented weather resistant barrier 100 allows for ventilation of VOCs from the inside of the structure to the exterior of the structure. VOCs, which may be released into the inside of the structure may come from any number of sources, such as vapors from volatile substances, cleaning products, and off-gassing from construction materials. Prior to inclusion of water and airtight components on wall coverings, a portion of VOCs within a structure were able to be vented from a structure by permeation of the VOCs through the wall covering material. However, the desire to prevent air flow or moisture exchange through the walls of structures has led to the use of wall coverings with barriers that prevent air or moisture permutation through the walls of the structures. Such wall coverings are useful in increasing the insulation value of a wall covering and in preventing moisture damage within a structure. However, such materials also potentially prevent the venting of VOCs through the wall, thereby resulting in an increased VOC concentration within a structure.

The use of vented weather resistant barrier 100 as an exterior wall covering or member allows for venting of VOCs through the walls of a structure while still utilizing moisture and air flow resistant barriers to prevent the ingress of moisture and air into the structure. VOCs permeate from the interior of a structure into the wall cavity 112. The panel 116, being porous in nature, allows for VOCs to further permeate through the panel 116. VOCs will eventually permeate through the panel 116 into the channels 128. Since the channels 128 are open on their lower end to the exterior of the structure and on their upper end to the attic cavity 176, a fluidly coupled ventilation pathway 136 is formed from the exterior of the structure through the lower end of the channels 128, through the channels 128, and into the attic cavity 176. The ventilation pathway 136 therefore allows the venting of VOCs that have permeated through the panel 116 into the channels 128. VOCs may exit the channels 128 directly to the exterior of the structure through the lower end of the channels 128, or VOCs may exit into the attic cavity 176 through the upper end of the channels 128. Transfer of VOCs into the attic cavity 176 effectively removes the VOCs from the livable portion of the structure, thereby reducing undesired exposure to VOCs by those within the structure. However, VOCs are further vented from the attic cavity 176 to the exterior of the structure through the attic vent 196 and the soffit vent 192.

To manufacture the vented weather resistant barrier 100, according to an illustrative embodiment, the panel 116, e.g., the OSB or plywood, is formed in the usual way as those skilled in the art will appreciate and then channels 128 are formed. In one embodiment, the channels 128 are formed using a specialty saw, which is like an industrial sized router, that cuts the grooves or channels 128. The depth 148 of the channel 128 is small enough that the channel 128 does not negatively impact structural integrity of the panel 116. In one embodiment in which the panel 116 is plywood, the depth 148 of the channel 128 is 50% of the thickness 165 of the panel 116. In one illustrative embodiment in which the panel 116 is OSB, the depth 148 (FIG. 2A) is 19/32″ and goes into center layer of the OSB, while maintaining its span rating. In some embodiments, the depth 148 is just sized to keep the Dept. of Commerce PS2 qualification span rating.

After the channels 128 are formed, an adhesive, or glue, is applied to the first side 120, omitting adhesive or glue in the channels 128 in many embodiments. Then, the foil layer 132, which may be backed by a carrier 144 as discussed above, is applied to the panel 116 using the adhesive. In some embodiments, the adhesive may be applied to the surface of the foil layer 132 or a carrier 144 backing of foil layer 132, and then applied onto the first side of the panel 116.

According to an illustrative embodiment, a method of applying a vented weather resistant barrier 100 to a structure includes coupling the vented weather resistant barriers 100 of the type described herein to the exterior side of wall framing members, i.e. the studs 104, bottom plate 160, top plate (top) 164, and top plate (bottom) 168 with the plurality of channels 128 parallel to the studs 104, with foil layer 132 facing the exterior of the structure and wherein at least some of the lower ends of the channels 128 are vented to the exterior of the structure and at least some of the upper ends of the channels 128 are vented into the attic cavity 176 of the structure.

According to an illustrative embodiment, a method of venting a structure using vented weather resistant barriers 100 includes applying a plurality of vented weather resistant barriers 100, as described herein, to an exterior side of a plurality of studs 104 of a wall of a structure with the plurality of channels 128 oriented parallel to the plurality of studs 104, with the barrier 134 facing towards an exterior of the structure with at least a first 129 or second end 130 of at least one of the plurality of channels 128 being in fluid communication with the exterior of the structure or with an attic cavity 176 of the structure. In some embodiments, the first end of the at least one of the plurality of channels 128 is in fluid communication (fluidly coupled) with the exterior of the structure and the second end of at least one of the plurality of channels 128 being is fluid communication with the attic cavity 176 of the structure.

For structures that exceed the length of the vented weather resistant barrier 100, multiple vented weather resistant barriers 100 are used to form flow paths from each vented weather resistant barrier 100 to either the exterior of the structure or to the attic cavity of the structure. For example, two or more vented weather resistant barriers 100 may be installed onto a structure with the plurality of channels 128 of each vented weather resistant barrier 100 aligned so that the plurality of channels 128 of one vented weather resistant barrier 100 are in fluid communication with the plurality of channels 128 of a different vented weather resistant barrier 100.

In the alternative, a flow path between the plurality of channels 128 of one vented weather resistant barrier 100 and the plurality of channels 128 of a second vented weather resistant barrier 100 can be formed by installing the vented weather resistant barriers 100 with an abutment gap between the vented weather resistant barriers 100. Such abutment gap is subsequently covered by final wall material, therefore creating a flow path between the plurality of channels 128 of one vented weather resistant barrier 100 and the plurality of channels 128 of a second vented weather resistant barrier 100. Such flow paths can be created as needed to fully cover the exterior wall of the structure so that the pluralities of channels 128 are in fluid communication with either the exterior of the structure, such as on the lower most vented weather resistant barrier 100, or with the attic cavity 176 of the structure, such as with the upper most vented weather resistant barrier 100.

While the description herein primarily describes use of the vented weather resistant barrier 100 as an exterior wall covering, one in the art will appreciate that use of the vented weather resistant barrier 100 is not limited to use as an exterior wall covering. For example, the vented weather resistant barrier 100 may be used as a roofing substrate or as a flooring substrate within a structure to allow for venting of VOCs from a structure in a manner similar to that describe herein related to wall coverings.

There are many examples of embodiments of the disclosure. Some examples follow.

Example 1. A vented weather resistant barrier panel comprising:
a panel having a first and a second side, wherein in an installed position the first side of the panel faces an exterior of a structure and the second side faces an interior of a structure;
wherein the panel is formed with a plurality of channels on the first side of the panel; and
a foil layer coupled to the first side of the panel and extending across the plurality of channels to form ventilation pathways.

Example 2. The vented weather resistant barrier panel of Example 1, wherein the panel comprises a structural wood-based panel.

Example 3. The vented weather resistant barrier panel of Example 2, wherein the structural wood-based panel is plywood or OSB.

Example 4. The vented weather resistant barrier panel of Examples 2 or 3, wherein the plurality of channels each have a depth in the ranges of 30-50% of a thickness of the panel.

Example 5. The vented weather resistant barrier panel of Examples 2, 3, or 4, wherein the foil layer is coupled to the first side of the panel by PVA glue.

Example 6. A method of applying a vented weather resistant barrier panel to a structure, comprising coupling vented weather resistant barrier panels of Example 1 to a plurality of wall studs with the plurality of channels substantially parallel to the plurality of wall studs.

Example 7. The method of Example 6 wherein an upper end of at least some of the plurality of channels are open and allows for venting from the channel to a soffit or attic of the structure.

Those skilled in the art will appreciate that the exterior joints may need to be taped in application. In one instance, a double acrylic adhesive tape with a reinforced scrim may be used.

Although the present invention and its advantages have been disclosed in the context of certain illustrative, non-limiting embodiments, it should be understood that various changes, substitutions, permutations, and alterations can be made without departing from the scope of the invention as defined by the claims. It will be appreciated that any feature that is described in a connection to any one embodiment may also be applicable to any other embodiment.

What is claimed:

1. A vented weather resistant barrier panel, comprising:
a panel having a first and a second side, wherein the panel is formed with a plurality of channels on the first side of the panel;
a non-perforated barrier coupled to the first side of the panel and extending across the plurality of channels to form ventilation pathways;
wherein, in an installed in position on framing members of a structure, the first side of the panel faces the exterior of a structure and the second side faces the interior of the structure;
wherein, the barrier comprises a foil layer and a carrier layer;
wherein, the carrier layer has a first side and a second side;
wherein, the foil layer has a first side and a second side;
wherein, the second side of the foil layer is coupled to the first side of the carrier layer, and
wherein, the second side of the carrier layer is coupled to the first side of the panel.

2. The vented weather resistant barrier panel of claim 1, wherein
the plurality of channels is formed along a longitudinal length of the panel and each of the plurality of channels is substantially parallel to each other.

3. The vented weather resistant barrier panel of claim 1, wherein the panel comprises a structural wood-based panel.

4. The vented weather resistant barrier panel of claim 3, wherein the structural wood-based panel is plywood.

5. The vented weather resistant barrier panel of claim 3, wherein the structural wood-based panel is oriented strand board.

6. The vented weather resistant barrier panel of claim 1, wherein at least one of the plurality of channels has a depth in the range of 30-50% of a thickness of the panel.

7. The vented weather resistant barrier panel of claim 6, wherein the thickness of the panel is in the range of 1.0-0.375 inches.

8. The vented weather resistant barrier panel of claim 1,
wherein the plurality of channels is formed along a longitudinal length of the panel and each of the plurality of channels is substantially parallel to each other;
wherein the panel is plywood or oriented strand board;
wherein at least one of the plurality of channels has a depth in the range of 30-50% of a thickness of the panel; and
wherein the thickness of the panel is in the range of 1.0-0.375 inches.

9. A method for ventilating a structure comprising the steps of:
attaching a plurality of vented weather resistant barrier panels to an exterior side of a plurality of studs of a wall of a structure, wherein each of the plurality of vented weather resistant barrier panels comprise:
a panel having a first and a second side, wherein the panel is formed with a plurality of channels on the first side of the panel with each of the pluralities of channel having a first end and a second end;
a barrier comprising a foil layer and a carrier layer, wherein the foil layer has a first side and a second side and the carrier layer has a first side and a second side, wherein the second side of the foil layer is coupled to the first side of the carrier layer, and
wherein the second side of the carrier layer of the barrier is coupled to the first side of the panel and the barrier extends across the plurality of channels to form ventilation pathways;
installing wall covering material over the second side of each of the plurality of vented weather resistant barrier panels;
wherein the plurality of vented weather resistant barrier panels is installed with the barrier facing the towards an exterior of the structure; and
wherein either the first end or the second end of at least one of the plurality of channels is in fluid communication with either the exterior of the structure or an attic cavity of the structure.

10. The method of claim 9, wherein the plurality of channels is formed along a longitudinal length of the panel and each of the plurality of channels are substantially parallel to each other.

11. The method of claim 9, wherein, when the plurality of vented weather resistant barrier panels is in the installed position, the plurality of channels of at least one vented weather resistant barrier panel is substantially parallel to the plurality of studs.

12. The method of claim 9, wherein the panel comprises a structural wood-based panel.

13. The method of claim 12, wherein the structural wood-based panel is plywood or oriented strand board.

14. The method of claim 9, wherein at least one of the plurality of channels has a depth in the range of 30-50% of a thickness of the panel.

15. The method of claim 14, wherein the thickness of the panel is in the range of 1.0-0.375 inches.

16. The method of claim 9,
wherein the plurality of channels is formed along a longitudinal length of the panel and each of the plurality of channels are substantially parallel to each other;
wherein, when the plurality of vented weather resistant barrier panels is in the installed position, the plurality of channels of at least one vented weather resistant barrier panel is substantially parallel to the plurality of studs;
wherein the panel is plywood or oriented strand board;
wherein at least one of the plurality of channels has a depth in the range of 30-50% of a thickness of the panel; and
wherein the thickness of the panel is in the range of 1.0-0.375 inches.

17. A vented weather resistant barrier panel for use in residential construction comprising:
a panel formed with a plurality of channels on one side running along a dimension of the panel and having a thickness of at least 0.25 inches;
a non-perforated barrier coupled over the plurality of channels of the panel to form a plurality of ventilation pathways;
wherein, the barrier comprises a foil layer and a carrier layer;
wherein, the carrier layer has a first side and a second side;
wherein, the foil layer has a first side and a second side;
wherein, the second side of the foil layer is coupled to the first side of the carrier layer, and
wherein, the second side of the carrier layer is coupled to the side of the panel having the plurality of channels.

18. The vented weather resistant barrier panel of claim 17, wherein the panel comprises a structural wood-based panel.

19. The vented weather resistant barrier panel of claim 17, wherein the panel has a thickness in the range of 1.0-0.375 inches.

20. The vented weather resistant barrier panel of claim 19, wherein a depth of at least one of the plurality of channels is in the range of 30-50% of a thickness of the panel.
